(19) United States
(12) Patent Application Publication
(10) Pub. No.: US 2005/0269823 A1
(43) Pub. Date: Dec. 8, 2005

(54) Structural beam incorporating wire reinforcement

(75) Inventors: Thomas F. DeVoursney, Muskegon, MI (US); Darin Evans, Wixom, MI (US)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: Shape Corporation

(21) Appl. No.: 11/142,608

(22) Filed: Jun. 1, 2005

Related U.S. Application Data
(60) Provisional application No. 60/576,098, filed on Jun. 2, 2004.

(51) Int. Cl. B60R 19/03

(52) U.S. Cl. 293/102

(57) ABSTRACT

A structural beam includes a polymeric beam section and a reinforcer comprising a pattern of stranded wires of high strength steel that selectively reinforces and stiffens the beam section for increased strength. The reinforcer can be positioned integrally within the beam, or attached to a rear of the beam where the beam has a rearwardly open section, or attached to a front of the beam such as to stiffen the front of the beam.

### CROSS-REFERENCE TO RELATED APPLICATIONS

This application claims benefit of provisional application Ser. No. 60/576,098, filed Jun. 2, 2004, entitled BUMPER SYSTEM INCORPORATING WIRE REINFORCEMENT, the entire contents of which are incorporated herein in their entirety.

### BACKGROUND

The present invention relates to bumper systems incorporating wire as a reinforcer.

Bumper systems in modern vehicles are tuned for optimal energy absorption and stress distribution during a vehicle collision. Bumper testing includes a variety of different impact tests, including center pole impact, frontal (flat-faced) pendulum impact, corner impact tests, and other tests, including new tests now being developed intended to test for pedestrian safety. It is no longer satisfactory to simply make a bumper beam stronger or heavier. Instead, increased flexibility is desired so that particular areas can be optimally tuned for overall strength and stress distribution as well as area-specific strength and stress distribution, and also where weight, material, and process costs are minimized. Also, it is desirable to provide a system permitting the bumper system to be easily tuned during development and testing. More broadly, structural beams are often used in vehicles for stress distribution, for carrying loads, and for withstanding impact. Structural beams are desired that are selectively strengthened in desired areas for optimal function.

Thus, a system having the aforementioned advantages and solving the aforementioned problems is desired.

### SUMMARY OF THE PRESENT INVENTION

In one aspect of the present invention, a structural beam includes a polymeric reinforced structural member with mounts at each end adapted for attachment, and further including a molded-in reinforcer comprising stranded wires.

In another aspect of the present invention, a beam includes a reinforced structural member with mounts at each end adapted for attachment to a vehicle; the reinforced structural member having top and bottom rear surfaces and an open section defining an open rear area. A reinforcer includes wires spanning the open rear area and attached to the top and bottom rear surfaces such that the reinforcer retains and stabilizes the open section during a vehicle impact.

In another aspect of the present invention, a beam includes a reinforced structural member with mounts at each end adapted for attachment to a vehicle, with the reinforced structural member having at least one wall forming a front surface. A reinforcer includes wires positioned on the front surface such that the reinforcer stabilizes the one wall during a vehicle impact.

In yet another aspect of the present invention, an energy absorber includes a molded polymeric beam member having a face wall. A plurality of reinforcing wires are embedded in the face wall, the wires having a tensile strength of at least about 120 KSI.

In another aspect of the present invention, a process of forming a reinforced structural member includes providing stranded wires interconnected and held in a pattern by plastic strands, the wires having a tensile strength of at least 120 KSI. The process further includes closing dies on the pattern of stranded wires form the wires to a new shape, and molding polymeric material onto the wires with the polymeric material forming a structural beam and with the wires being embedded in and thus reinforcing selected areas of the structural beam.

These and other aspects, objects, and features of the present invention will be understood and appreciated by those skilled in the art upon studying the following specification, claims, and appended drawings.

### BRIEF DESCRIPTION OF DRAWINGS

FIGS. 1-2 are top and cross-sectional views of a first embodiment bumper system, with FIG. 2A showing the reinforcer in more detail.

FIGS. 3-4 are perspective and cross-sectional views of a second embodiment bumper system.

FIGS. 5-6 are perspective and cross-sectional views of a third embodiment bumper system.

FIGS. 7-8 are perspective and cross-sectional views of a fourth embodiment bumper system.

FIG. 9 is an exploded perspective view of a fifth embodiment bumper system.

FIG. 10 is a front perspective view of a sixth embodiment bumper system.

FIG. 11 is a fragmentary rear perspective view of an end section of FIG. 10.

FIGS. 12-14 are cross sectional views taken along the lines XII-XII, XIII-XIII and XIV-XIV in FIG. 10.

FIG. 12A is an enlarged end view of a bundle of twisted stranded wires from FIG. 12.

FIG. 15 is a front perspective view of a seventh embodiment bumper system.

FIG. 16 is an enlarged front view of a center section of FIG. 15, with the polymeric material being shown as transparent so that a density of the stranded wires can be seen.

### DETAILED DESCRIPTION OF PREFERRED EMBODIMENTS

The present invention includes a bumper system having a beam section and a reinforcer that selectively reinforces and stiffens that beam section for increased strength. As illustrated below, the reinforcer can be positioned integrally within the beam, attached to a rear of the beam, or attached to a front of the beam.

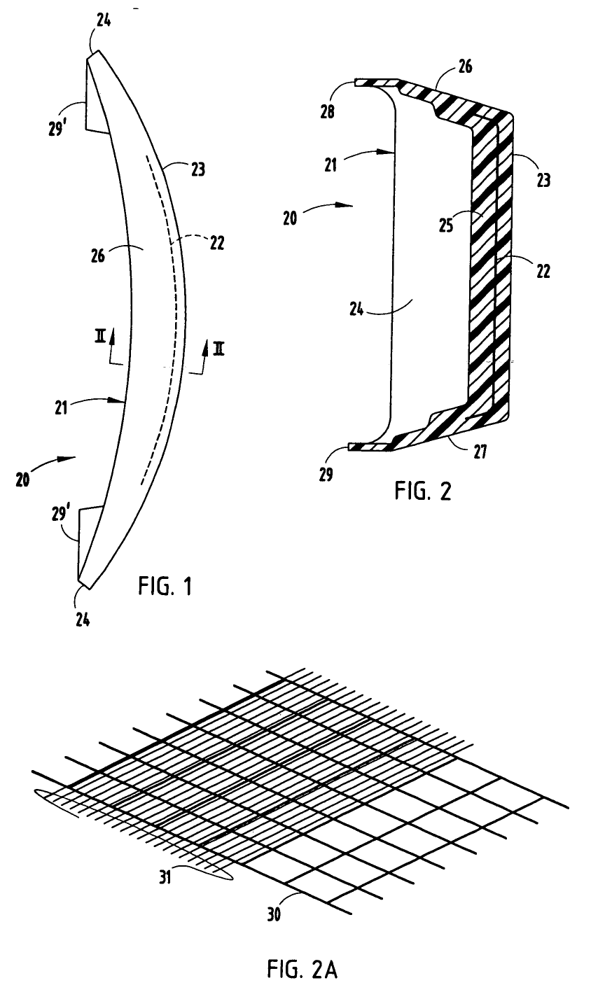

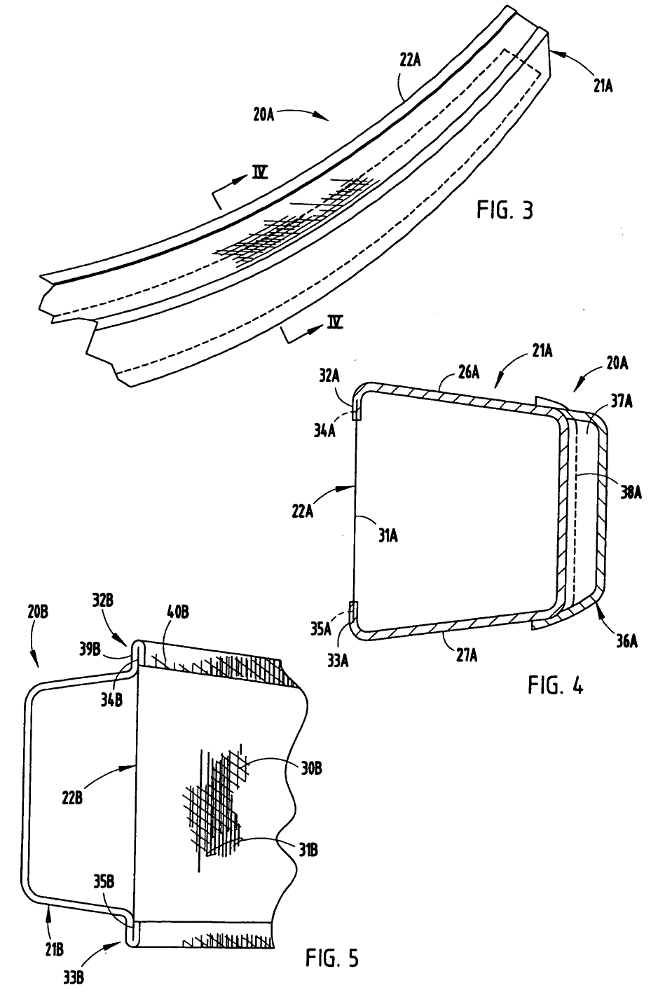

The structural beam system 20 (FIGS. 1-2) (also called a “reinforced structural member” herein) includes a beam section 21 made of polymeric (i.e. plastic) material with a reinforcer 22 comprising a pattern of wires 31 that are insert-molded into the beam section 21. It is contemplated that the beam section 21 can be any shape, including the illustrated shape which has a C-shaped cross section with swept curvilinear front surface 23 and partially closed ends 24 of increased sweep. For example, it is contemplated that the beam section 21 could also have a W-shaped, or I-beam-shaped cross section. The illustrated beam section 21 includes front, top, and bottom walls 25-27 with rear edge surfaces 28 and 29 on the top and bottom walls 26-27, respectively. In beam section 21, the rear surfaces 28 and 29 are not attached to each other, although it is contemplated that they could be (see FIGS. 3-8) and that a reinforcer could also be positioned on the face or front surface 23 (see FIG. 9). It is contemplated that a mount 29′ can be attached to or integrally formed on a rear surface at each end of the beam, such as for attachment to vehicle frame rails or to door frame structure.

The reinforcer 22 is a subassembly that includes crisscrossed plastic strands 30 that form an orthogonal matrix bonded to the wires 31. The matrix is relatively flexible and “floppy” in a direction perpendicular to a length of the wires, but is sufficient to provide stability and spacing to the wires 31, so that the assembly can be handled and manipulated during insert-molding into (or assembly to) the beam section 21. Advantageously, the wires 31 can be any strength, size, tensile strength, and other property as desired. The reinforcer 22 is flexible and bendable about an axis parallel the wires 31, and further can be formed to a three-dimensional preformed shape by bending the wires along their length, if desired. In one form, the wires 31 are high-strength wires, and in another form, the wires are ultra-high-strength wires having a tensile strength of greater than 80 KSI, or preferably of greater than 120 KSI, or most preferably of greater than 200 KSI. In one form, each of the illustrated wires 31 are actually a plurality of stranded wires twisted together to form a wire cable. Notably, the wire cable or bundled stranded wires provides surface area and also crevices for the plastic material of beam section 21 to bond to and penetrate, thus resulting in a stronger beam.

In the present disclosure and claims, it is intended that the term “wire” cover the concept of a wire cable and bundled stranded wires as well as individual wires. It is noted that a product comprising a subassembly of high strength bundled wires to an orthogonal array of plastic strands is commercially available and is made by a company called Hardwire™, located in Pocomoke City, Md. It is contemplated that the reinforcer 22 will be a sheet having a consistent and close spacing of the parallel wires 31, and a fairly wide spacing of the plastic strands 30 . . . and that pieces of the reinforcer 22 will be positioned as desired in the beam section 21. For example, a section of reinforcer 22 may be positioned near a center of the beam section 21 to provide for improved strength to withstand a center pole impact. Also, the reinforcer 22 may be cut short of ends of the beam section 21 where less strength is desired. However, it is contemplated that the reinforcer 22 itself can also be custom made to have increased or decreased density of wires in specified areas, if desired.

It is contemplated that the present structural member 20 can be made by placing a flat piece of the reinforcer 22 (i.e., a sheet of the wires 31 held together by plastic strands 30) into a mold. The wires 31 would be formed when the die is closed, and then held in the desired shape when the polymeric material of the beam section 21 is melted onto or injected into the reinforcer to form the final shape of the beam section 21. Alternatively, the wires 31 could be preformed prior to their placement in the mold.

Several additional embodiments are illustrated in FIGS. 3-9. In these additional embodiments, identical and similar features and aspects are identified by use of the same number, but with the addition of a letter “A”, “B”, “C”, and “D”. This is done to reduce redundant discussion, and not for another purpose.

The beam system 20A (FIGS. 3-4) (also called a “reinforced structural member” herein) includes a C-shaped beam section 21A (which may be polymeric, reinforced polymeric, or metal . . . such as a roll-formed section) and a reinforcer 22A having a pattern of wires 31A. Flanges 32A and 33A extend inwardly in alignment from the rear ends of the top and bottom walls 26A-27A. The illustrated reinforcer 22A includes edges 34A and 35A that are insert-molded into the flanges 32A and 33A. It is contemplated that the edges 34A and 35A could be welded or bonded to the flanges 32A and 33A, as well (i.e., when the beam section 21A is metal). It is also contemplated that the flanges 32A and 33A could extend outwardly instead of extending toward each other as shown in FIG. 4.

An energy absorber 36A is positioned on a face surface of the beam section 21A. It is contemplated that the energy absorber 36A can be a traditional polymeric energy absorber with or without traditional reinforcing material. It is contemplated that the energy absorber 36A may also include an imbedded reinforcer like reinforcer 22A (or like reinforcer 22). Alternatively, the reinforcer could be applied to a surface of the energy absorber, such as may occur when the energy absorber 36A is thermoformed. As illustrated, the energy absorber 36A is thermoformed from a sheet of thermoplastic material, and includes crush boxes 37A that extend forwardly from a base layer 38A. It is contemplated that ultra high strength steel wires (UHSS) can be embedded in the energy absorber 36A, much like the arrangement shown in FIG. 2. It is contemplated that the reinforcer will be preformed to a three-dimensional shape that mates with the thermoformed plastic during the thermoforming process. Notably, top and bottom ends of the base layer 38A can be formed to frictionally engage top and bottom edges of the beam section 21A for temporarily retaining the energy absorber 36A onto the beam section 21A.

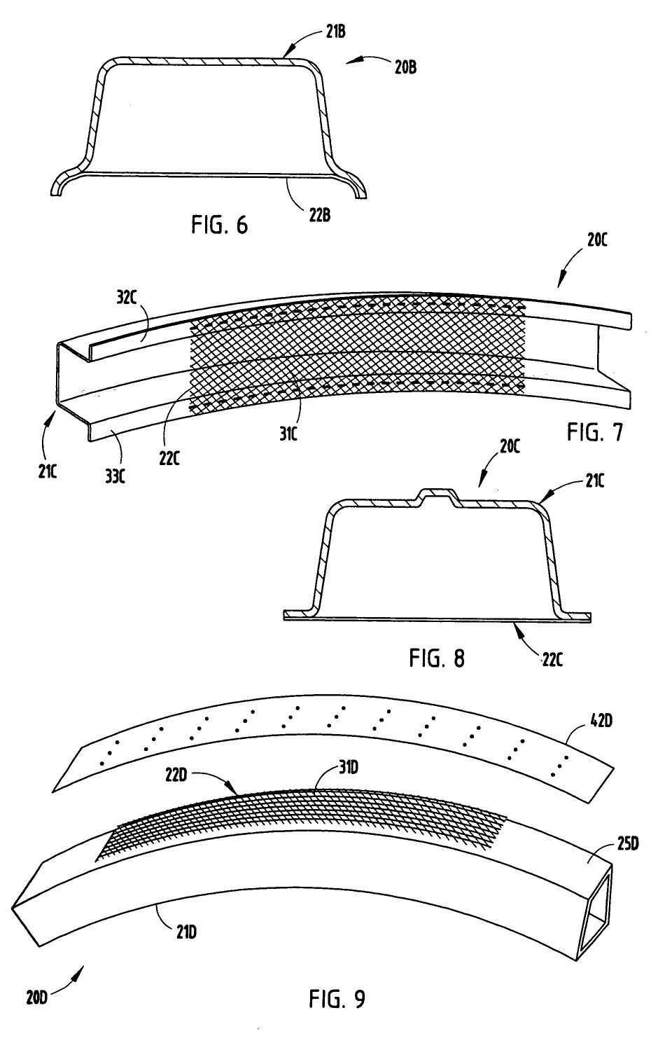

The beam system 20B (FIG. 5) includes a hat-shaped beam section 21B similar to the beam section 21A (FIG. 3), but has the flanges 32B and 33B extending outwardly. A reinforcer 22B includes edges 34B and 35B positioned on and engaging a first portion 39B of the flanges 32B and 33B. A reversely-bent portion 40B clampingly engages the edges 34B and 35B to retain the reinforcer 22B on the beam section 21B. It is noted that where additional retention is desired, the portions 39B and 40B can be welded or otherwise secured together (such as mechanically by rivets or the like) for increased clamping strength. Notably, the reinforcer 22B includes both the wires 31B and the plastic strands 30B. However, it is conceived that a reinforcer 22B comprising only wires 31B could also be used where the assembly process is adapted to handle and position a plurality of wires on a rear of the beam section 21B until attachment of the reinforcer 22B to the beam section 21B. The beam shown in FIG. 6 is identical to that shown in FIG. 5, except in FIG. 6, the flanges 32B and 33B are curved instead of planar. The curved flanges 32B and 33B create a concavity useful for matingly engaging a face of a bumper beam, which would help hold the beam section 21 on the face of a tubular primary bumper beam, for example. It is noted that the beam section 21B could be a roll-formed sheet of metal, or could be a molded component with embedded reinforcement wires similar to that shown in FIG. 2.

The beam system 20C (FIGS. 7-8) includes a C-shaped beam section 21C similar to the beam section 21B and with wires 31C bonded to the flanges 32C and 33C by welding. In the reinforcer 22C, the wires 31C are formed into a crisscrossing matrix. It is contemplated that the wires 31C could be crimped or stamped to help the crisscrossed wires retain their pattern without the use of plastic strands. Alternatively, the wires 31C can be tack-welded or bonded by adhesive drops at a sufficient number of crisscross joints so that the reinforcer 22C maintains its shape while being handled. Notably, the ends of the wires 31C can be secured by a continuous bead, or by a C-shaped clip that engages the flanges 32C and 33C and that is periodically welded (e.g., MIG, TIG or other).

The beam system 20D (FIG. 9) includes a beam section 21D and reinforcer 22D positioned on a front surface of its front wall 25D. The wires 31D are positioned vertically, horizontally, diagonally, or in any desired pattern. The reinforcer 22D is retained to the front wall 25D by any desired means. For example, a sheet metal cover 42D is shown which is spot-welded to the front wall 25D covering the wires 31D. Alternatively, a bonding agent can be used alone or in combination with the cover 42D. Alternatively, a fascia (not shown) can be used to retain the assembly together. Alternatively, it is contemplated that the reinforcer 22D could be preformed into a hat-shape to absorb energy prior to impacting a face of the beam section 21D.

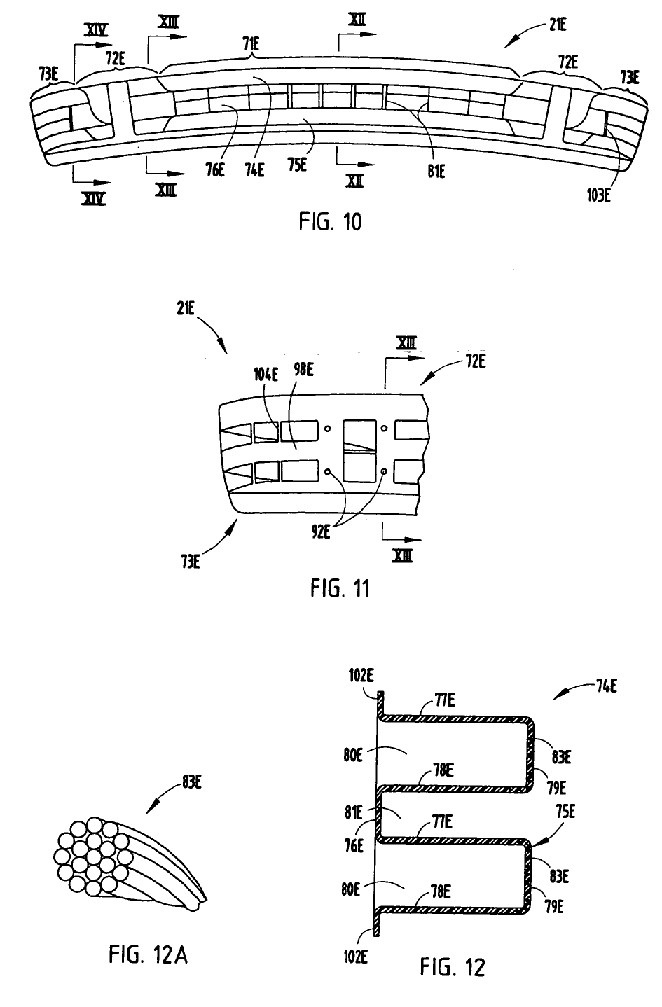

The beam section 21E (FIGS. 10-14) combines features of a rigid reinforcement beam and an energy absorber, by combining a particular polymeric molded shape with embedded UHSS stranded wires as follows. By this arrangement, the need for a separate (traditionally metal) reinforcement beam and separate (traditionally polymeric) energy absorber on a traditional vehicle front or rear bumper system is potentially eliminated. Also, the beam section 21E allows hybrid components to be designed having very specific impact and strength characteristics in different regions, such that the beam section 21E is also highly useful in door beams, roof beams, and many other places in a vehicle or in non-vehicle applications where particular strength characteristics are desired.

The beam section 21E includes a polymeric material molded into a desired beam shape. The illustrated polymeric material is PC/PBT material, which is often used for energy absorbers for vehicle bumper systems. For example, Xenoy® material made by GE Corporation can be used. The beam shape includes a center section 71E, mounting sections 72E at each end of the center section 71E, and corner sections 73E at the outboard ends. The center section 71E includes top and bottom U-shaped portions 74E and 75E connected by a flange 76E. The U-shaped portions 74E and 75E each include top and bottom walls 77E and 78E connected by a front wall 79E to define cavities that open rearwardly, and further include vertical ribs 80E that extend in a fore/aft direction to connect and rigidify the walls 77E-79E. Further, reinforcing ribs 81E extend between the top and bottom U-shaped portions 74E and 75E, thus forming a plurality of box-like sections well adapted to crush and absorb energy upon a vehicle impact. The front walls 79E on portions 74E and 75E have embedded reinforcers 22E which include a plurality of twisted bundles of stranded wires 83E (FIG. 12A). The stranded wires 83E extend longitudinally along the front walls 79E for a length of the center section 73E, but terminate at or slightly short of the mounting sections 72E. The stranded wires 83E may also be present in the forward portions of the top and bottom walls 77E and 78E (see FIG. 12) (and/or the stranded wires 83E can be present at any location throughout the beam section 21E as desired). Notably, the illustrated beam section 21E is relatively straight but does have a small sweep (i.e. longitudinal curvature). It is contemplated that the stranded wires 83E can be held together as a pre-assembly with a matrix of plastic threads, as shown in FIG. 2A and previously described. The pre-assembly of stranded wires 83E can a planar shape when in a free unstressed state, and be placed in a female half of the molding dies where, when closed, the molding dies form the stranded wires 83E along the front walls 79E to the longitudinally curved shape of the final part.

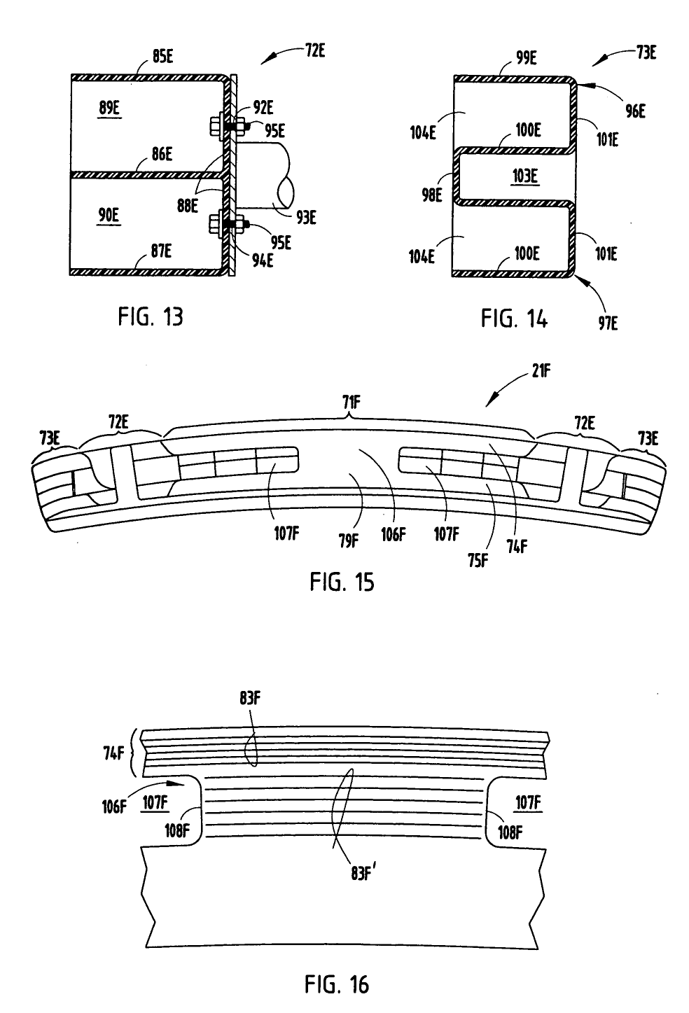

The cross sectional shape of the molded beam changes as it extends from the center section 71E (which in the illustrated beam is generally “W” shaped) and transitions into the mounting sections 72E at each end of the center section 71E, and then changes again as the cross section transitions into the corner sections 73E at the outboard ends. The illustrated mounting sections 72E (FIG. 13) are integrally formed as part of the beam shape, and include top, intermediate and bottom walls 85E, 86E and 87E interconnected by a rear wall 88E and vertical ribs 89E and 90E as required for stiffness and structural integrity. A relatively flat rear surface is formed on at the mounting sections 72E, and attachment holes 92E are provided in the rear wall 88E. A vehicle frame rail 93E includes an attachment plate 94E having holes matching the pattern of holes 92E, so that bolts 95E can be used to secure the beam section 21E to the vehicle.

The illustrated corner sections 73E have cross section shapes not unlike the shape of the center section (see FIG. 14), including top and bottom U-shaped sections 96E and 97E interconnected by a rear wall 98E, each U-shaped section including top and bottom walls 99E and 100E connected by front walls 101E. However, the rearward edge of the topmost wall 99E and the bottommost wall 100E do not include flanges like the upwardly and downwardly extending flanges 102E on the topmost and bottommost walls of the center section 71E (FIG. 12). (The flanges 102E are provided for increased stability of the walls along the center section 71E, if desired.) Also, the corner sections 73E (when viewed from above) are wedge-shaped or triangularly shaped with narrow outboard ends. They include a front surface that curves rearwardly at a sweep rate increasingly greater than the sweep defined along a front surface of the center section. This is to provide a more aerodynamic appearance to the vehicle, as is sometimes done in modern vehicle designs. Notably, vertical ribs 103E extend between the U-shaped sections 96E and 97E and ribs 104E extend internally within each U-shaped section 96E and 97E for increasing a strength and integrity of the corner section. It is noted that the wedge-shape of the corner sections 73E provides a more pedestrian-friendly bumper, since the corner sections 73E will flex in response to striking a pedestrian. The flexibility of the corner section is maintained and is consistent with an absence of the UHSS stranded wires in the illustrated beam 21E , which are present only in the center section 71E and not in the mounting and corner sections 72E and 73E.

A beam section 21F (FIGS. 15-16) provided that is similar to the beam section 21E, except that beam section 21F includes a panel section 106F in a middle of the center section 71F, where the front walls 79F of the top and bottom U-shaped portions 74F and 75F are interconnected to form a large flat front surface. Apertures 107F (or depressions) are formed on either side of the panel section 106F, such as for mounting rear tail lights (i.e. on a vehicle rear bumper) or for passing air therethrough (such as to an engine) (i.e. on a vehicle front bumper).

As shown in FIG. 16, the density of the stranded wires changes over different parts of the beam section 21F. The front wall 79F of the top U-shaped portion 74F includes a plurality of bundles of twisted stranded wires 83F spaced relatively close together and extending a length of the center section 71F of the beam section 21F. Contrastingly, the stranded wires 83F′ in the center panel section 106F (i.e. below the U-shaped portion 74F) are spaced farther apart. Also, the stranded wires 83F′ in the center panel section 106F are shorter, and terminate short of the side edges 108F of the panel section 106F, so that ends of the stranded wires 83F′ are not exposed. Thus, the panel section 106F is strengthened by the stranded wires 83F′, but to a lesser extent than the top U-shaped portion 74F.

It is contemplated that the beam section 21F can be made of a colored material, or that it can be made of a material that can be painted, thus eliminating the need to cover it with a fasica. Fascia is often made from a material such as a reaction injection molded (RIM) material, or a glass reinforced RIM material, which is not inexpensive to purchase, manufacture, and assemble . . . such that its elimination can be a significant cost savings. Further, it is contemplated that the polymeric material of the beam section 21F can actually include a foaming agent, thus reducing its density and weight, while still obtaining the benefit of the high strength wires placed within the beam section 21F. In one form, it is contemplated that in some applications the UHSS stranded wires can be placed (secondarily or insert-molded therein) within a RIM material, thus forming a structural beam.

It is contemplated that the concept of using a reinforcer (e.g., reinforcer 22, 22A, 22B, 22C, 22D, 83E, 83F) on or within a beam section (e.g., beam section 21, 21A, 21B, 21C, 21D, 21E, 21F) as disclosed herein could be adapted for use on any beam component in a vehicle, where a high strength-to-weight ratio is desired and where high-impact strength is desired. For example, such beams are often used in doors to improve vehicle side impact, or in roof supports, or roof-supporting pillar members, or in instrument panel support members, or in other locations on a vehicle to improve strength characteristics while maintaining a lower weight.

It is to be understood that variations and modifications can be made on the aforementioned structure without departing from the concepts of the present invention, and further it is to be understood that such concepts are intended to be covered by the following claims unless these claims by their language expressly state otherwise.

1. A structural beam comprising:
a polymeric reinforced structural member with mounts at each end adapted for attachment, the reinforced structural member including a molded-in reinforcer comprising stranded wires.

2. The beam defined in claim 1, wherein the reinforcer includes a plurality of plastic strands interconnecting the wires to retain the wires in a selected pattern prior to molding in the wires.

3. The beam defined in claim 2, wherein the wires all extend parallel each other.

4. The beam defined in claim 1, wherein the wires are positioned in selected areas in the reinforced structural member and do not extend continuously along an entire length of the reinforced structural member.

5. The beam defined in claim 1, wherein the wires are made of material having a tensile strength of at least 120 KSI.

6. The beam defined in claim 1, wherein the wires are made of material having a tensile strength of at least 200 KSI.

7. The beam defined in claim 1, wherein the wires each comprise a bundle of twisted metal stranded wires.

8. The beam defined in claim 1, including a metal vehicle bumper beam, and wherein the reinforced structural member is an energy absorber engaging a face of the bumper beam.

9. The beam defined in claim 1, wherein the wires all extend parallel to each other.

10. A beam comprising:
a reinforced structural member with mounts at each end adapted for attachment to a vehicle; the beam having top and bottom rear surfaces and an open section defining an open rear area; and
a reinforcer including wires spanning the open rear area and attached to the top and bottom rear surfaces such that the reinforcer retains and stabilizes the open section during a vehicle impact.

11. The beam defined in claim 10, wherein the wires each include ends attached to the top and bottom rear surfaces.

12. The beam defined in claim 11, wherein the ends are insert-molded into top and bottom walls of the open section, the top and bottom walls including the rear surfaces.

13. The beam defined in claim 10, wherein the reinforcer includes plastic strands interconnecting the wires to retain the wires in a selected pattern until at least the wire ends are attached.

14. The beam defined in claim 10, including an energy absorber positioned on a face of the beam, the energy absorber also including a pattern of wires.

15. The beam defined in claim 10, wherein the beam includes rear flanges that are positioned in a common plane and that define the rear surfaces when the beam is viewed in cross section.

16. The beam defined in claim 10, wherein the wires are attached to the rear surfaces by bonding material such as welding and brazing

17. The beam defined in claim 10, wherein the reinforcer includes plastic strands interconnecting the wires to retain the wires in a selected pattern until at least the wire ends are attached.

18. The beam defined in claim 10, wherein the wires include a plurality of stranded wires twisted together to form a cable-like wire.

19. A beam comprising:
a beam with mounts at each end adapted for attachment to a vehicle; the beam having at least one wall forming a front surface; and
a reinforcer including wires engaging the front surface such that the reinforcer stabilizes the one wall during a vehicle impact.

20. The beam defined in claim 19, wherein the reinforcer is positioned at least across a center of the front surface for stabilizing a front center area during a pole impact.

21. The beam defined in claim 19, including a cover attached to the beam and at least partially covering the reinforcer.

22. The beam defined in claim 19, wherein the front surface is three-dimensionally shaped, and wherein the reinforcer is formed to a non-planar shape to nestingly engage the front surface.

23. An energy absorber comprising:
a molded polymeric beam member having a face wall;
a plurality of reinforcing wires embedded in the face wall, the wires having a tensile strength of at least about 120 KSI.

24. A process of forming a reinforced structural member comprising:
providing stranded wires interconnected and held in a pattern by plastic strands, the wires having a tensile strength of at least 120 KSI;
closing dies on the pattern of stranded wires to form the wires to a new shape; and
molding polymeric material onto the wires with the polymeric material forming a structural beam and with the wires being embedded in and thus reinforcing selected areas of the structural beam.
